(19) United States
(12) Patent Application Publication
(10) Pub. No.: US 2009/0310940 A1
(43) Pub. Date: Dec. 17, 2009

(54) Reproduction control device, method, and program

(75) Inventor: Katsuya Ishimoto, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-Shi (JP)

(21) Appl. No.: 12/457,491

(22) Filed: Jun. 12, 2009

(30) Foreign Application Priority Data
Jun. 12, 2008 (JP) 2008-154435

(51) Int. Cl. H04N 5/91

(52) U.S. Cl. 386/96; 386/E05.003

(57) ABSTRACT

A reproduction control device (10), which is connected to a content reproduction system (1) comprises: a selection instruction reception unit (22) that receives a next-audio-data selection instruction to cause a piece of audio data, which is listed next to a piece of audio data to be reproduced, to be selected as a new piece of audio data to be reproduced; an instruction count recording unit (24) that records a number of the successively received next-audio-data selection instructions; and a selection instruction output unit (25) that outputs a specified-audio-data selection instruction to cause a piece of audio data, which is listed after the piece of audio data to be reproduced with an interval corresponding to the recorded number of the next-audio-data selection instructions, to be selected as the new piece of audio data to be reproduced.

### CROSS-REFERENCE TO RELATED APPLICATION

This application is based upon and claims the benefit of priority of the prior Japanese Patent Application No. 2008-154435, filed on Jun. 12, 2008, the entire contents of which are incorporated herein by reference.

### FIELD

The present invention relates to a content reproduction system that reproduces, along with a video, an audio based on audio data selected from a plurality of pieces of audio data.

### BACKGROUND

Conventionally, there has been proposed an electronic device that displays, when a plurality of instructions made by a user are successively input, an image on a display, which corresponds to a selected part of instructions including at least an instruction input last out of the group of the successively input instructions (refer to Patent document 1). Moreover, there is proposed a computer that validates only the first key input when inputs are carried out successively (refer to Patent document 2).
[Patent document 1] JP 2007-241492 A
[Patent document 2] JP 08-255138 A

### SUMMARY

Conventionally, there has been proposed a technology of reproducing a video and audio by recording videos and audios constituting a content as digital data, and by creating a video signal and an audio signal from the data. Moreover, pieces of raw video and audio data are large in size, and thus, are generally compressed and then recorded. As one of those technologies, there is the DivX (registered trademark) which is a content compression codec developed by DivX, Inc. This method has a feature that a movie of two hours recorded as DVD-Video having information of approximately 8 gigabytes (GB) in data size can be compressed down to a size of approximately 700 megabytes (MB), which can be stored on one CD, and, at the same time, is less degraded compared with the video before the compression.

Moreover, regarding a content constituted by videos and audios, conventionally, for one video, by reproducing, along with the video, an audio relating to a piece of audio data selected from a plurality of pieces of audio data recorded in the same content, a multi-language functionality and the like can be provided. According to the DivX standard, similarly to the DVD-Video standard, a plurality of pieces of audio data (eight audios at most) are packaged with one piece of video data as a set to constitute the content, and, upon reproduction, an audio based on a piece of audio data selected out of the plurality of pieces of audio data can be reproduced along with a video.

On this occasion, when a video signal and an audio signal are created from compressed data, preprocessing starting from reading the data and ending with decompressing data at the beginning is generally necessary. This preprocessing is generally necessary for reproduction using compressed data, but, especially in the case of the DivX, for the sake of the specification, it is necessary to pause the video and audio when the audio is switched. As a result, when a DivX content is reproduced on a general reproduction system employing a user interface which sequentially switches among a plurality of audios for reproduction according to an operation of switching an audio (such as depression of an audio button), each time the operation of switching the audio is carried out, a video pause/silent state occurs for approximately one to two seconds. Especially, when the switching operation is successively carried out in order to switch to an audio listed after a plurality of audios, the pause and the reproduction for the preprocessing are repeated as many times as the number of the operations, and, until the switching to the target audio is completed, a user has to wait in the video pause/silent state for a period of time exceeding “number of operations×period of time required for one switching” (refer to FIG. 6).

The present invention has been made in view of the problem, and it is therefore an object thereof to reduce the waiting time of a user when an audio reproduced along with a video is switched, and to improve response of the reproduction system.

In order to solve the problem, according to the present invention, an actual switching instruction is not issued while instructions to select next audio data are successively received, but a summarized instruction based on contents of the successive operations is issued once after the successive operations have been completed. Accordingly, it is possible to reduce the waiting time of the user when the audio reproduced along with the video is switched, and improve the response of the reproduction system.

Specifically, the present invention provides a reproduction control device connected to a content reproduction system that reproduces, along with a video based on video data, an audio based on a piece of audio data to be reproduced, which is selected out of a plurality of pieces of audio data that require preprocessing to be carried out before start of reproduction, and constitute a content along with the video data. The reproduction control device comprises: selection instruction reception means for receiving a next-audio-data selection instruction to cause a piece of audio data, which is listed next to the piece of audio data to be reproduced, to be selected as a new piece of audio data to be reproduced out of the plurality of pieces of audio data; instruction count recording means for recording a number of the next-audio-data selection instructions successively received by the selection instruction reception means; and selection instruction output means for outputting, to the content reproduction system, a specified-audio-data selection instruction to cause a piece of audio data, which is listed after the piece of audio data to be reproduced with an interval corresponding to the number of the next-audio-data selection instructions recorded by the instruction count recording means, to be selected as the new piece of audio data to be reproduced out of the plurality of pieces of audio data.

The reproduction control device is a device that controls a flow of the reproduction carried out in the content reproduction system, and, for example, corresponds to a deck that creates a video signal and an audio signal based on the data read out from the recording medium, or a deck controller that receives an operation carried out by a user, and controls the reproduction deck in the content reproduction system. Moreover, the reproduced content according to the present invention is a content relating to a combination of video data and audio data, and a plurality of pieces of selectable audio data are combined with the video data. The content according to the present invention is, for example, a movie in which an audio can be selected from audios in a plurality of languages.

On this occasion, the preprocessing to be carried out before the start of the reproduction refers to processing on a preparation stage carried out before audio signal creation processing sequentially carried out in parallel with the reproduction when an audio signal used for reproduction is created from audio data, and involves processing of reading out data necessary for the reproduction from a recording medium, processing of loading the data on a storage system, processing of decoding compressed data (especially a header portion of the data), and processing of synchronizing the reproduced audio with the video.

According to the present invention, the selection instruction reception means receives the next-audio-data selection instruction which is a selection instruction to specify, as a new reproduction subject, the piece of audio data listed next to the piece of audio data to be reproduced. Conventionally, even when the selection instructions are successively received, based on the received selection instructions, the reproduction control device instructs the reproduction processing unit of the content reproduction system to pause the reproduction of the piece of audio data to be reproduced currently, and to reproduce the piece of audio data listed next. However, according to the present invention, the instruction count recording means records the number of the next-audio-data selection instructions which are successively received, and the selection instruction output means instructs the content reproduction system to reproduce the piece of audio data listed afterward with the interval corresponding to this number.

As a result, in the content reproduction system, the preprocessing before reproducing audio data is not carried out for all the next-audio-data selection instructions which are successively carried out, but the preprocessing before reproducing audio data is carried out only for the audio data specified last by the successive instructions, and hence it is possible to reduce a waiting time of a user caused by switching of audio data, thereby improving a response of the content reproduction system. The present invention especially exhibits the effect for reproduction of a content compliant to a standard such as the DivX in which a video and an audio are paused when audio data is switched, but the standard for contents to which the present invention is applicable is not limited to the DivX. As long as a content requires preprocessing for switching an audio, by applying the present invention, the effects such as the improvement in response can be obtained.

It should be noted that the plurality of pieces of audio data are preferably listed in a form of loop. By listing the audio data in the form of loop, when the next-audio-data selection instruction is received at the terminal end of the list, it is possible to return to the top of the list, and successively select audio data again from the top.

The reproduction control device according to the present invention may further comprise time passage monitoring means for monitoring a passage of a period of time until a passage of a predetermined period of time is detected after the next-audio-data selection instruction is last received by the selection instruction reception means, wherein: the instruction count recording means may record the number of the next-audio-data selection instructions received by the selection instruction reception means after the selection instruction reception means receives the next-audio-data selection instruction while the time passage monitoring means has not started the monitoring until the time passage monitoring means detects the passage of the predetermined period of time; and the selection instruction output means may output, when the time passage monitoring means detects the passage of the predetermined period of time, the specified-audio-data selection instruction to the content reproduction system.

With this configuration, by regarding instructions successively received in the predetermined period of time as successive instructions, and instructing selection of the piece of audio data listed afterward with the interval corresponding to the number of the group of instructions which are successively received, the piece of audio data indicated last by the group of successive instructions can be selected. Specifically, a next-audio-data selection instruction received in a state in which the time passage monitoring means has not started the monitoring is a first instruction out of the group of successive instructions, and a next-audio-data selection instruction received immediately before the time passage monitoring means detects the passage of the predetermined period of time is the last instruction out of the group of successive instructions. The reproduction control device according to the present invention counts the number of instructions from the first instruction to the last instruction, calculates which piece of audio data out of the list is the finally specified piece of audio data, and issues the instruction.

The reproduction control device according to the present invention may further comprise display instruction output means for outputting, when the selection instruction reception means receives the next-audio-data selection instruction, regardless of whether or not the selection instruction output means outputs the selection instruction to the content reproduction system, an instruction to display, on a display unit provided on the content reproduction system, a notification that the piece of audio data, which is listed next to the piece of audio data to be reproduced, out of the plurality of pieces of audio data, has become the new piece of audio data to be reproduced.

On this occasion, the display unit is a display provided in the content reproduction system or the like. For example, in a conventional reproduction system as illustrated in FIG. 6, displaying of an audio number is updated on the display only after an audio has been switched, and thus, when the switching operation is carried out successively, there is a problem that a response of the displaying extremely degrades. According to the present invention, regardless of whether or not an instruction of audio data selection is actually issued to the content reproduction system, by the display instruction output means returning a response to the received next-audio-data selection instruction, the result of the operation is displayed following the user operation, and regardless of the actual period of time for the preprocessing required for switching audio data, the user can recognize that the operation has been received without delay.

Moreover, the present invention can also be interpreted as inventions of a reproduction control method and a reproduction control program carried out in a content reproduction system, and a computer-readable recording medium recording the reproduction control program. For example, the present invention provides a reproduction control method carried out by a reproduction control device connected to a content reproduction system that reproduces, along with a video based on video data, an audio based on a piece of audio data to be reproduced, which is selected out of a plurality of pieces of audio data that require preprocessing to be carried out before start of reproduction, and constitute a content along with the video data. The reproduction control method comprises: a selection instruction reception step of receiving a next-audio-data selection instruction to cause a piece of audio data, which is listed next to the piece of audio data to be reproduced, to be selected as a new piece of audio data to be reproduced out of the plurality of pieces of audio data; an instruction count recording step of recording a number of the next-audio-data selection instructions successively received in the selection instruction reception step; and a selection instruction output step of outputting, to the content reproduction system, a specified-audio-data selection instruction to cause a piece of audio data, which is listed after the piece of audio data to be reproduced with an interval corresponding to the number of the next-audio-data selection instructions recorded in the instruction count recording step, to be selected as the new piece of audio data to be reproduced out of the plurality of pieces of audio data.

According to the present invention, it is possible to reduce the waiting time of the user when the audio reproduced along with the video is switched, and improve the response of the reproduction system.

### BRIEF DESCRIPTION OF THE DRAWINGS

FIG. 1 is a diagram illustrating a schematic configuration of a content reproduction system according to embodiments.

FIG. 2 is a diagram illustrating functional configuration of a reproduction control device according to the embodiments.

FIG. 3 is a sequence diagram illustrating a flow of reproduction control processing according to a first embodiment.

FIG. 4 is a flowchart illustrating a flow of the reproduction control processing involving accumulation processing according to the embodiments.

FIG. 5 is a sequence diagram illustrating a flow of reproduction control processing according to a second embodiment.

FIG. 6 is a sequence diagram illustrating a flow of audio switching performed in a conventional reproduction system.

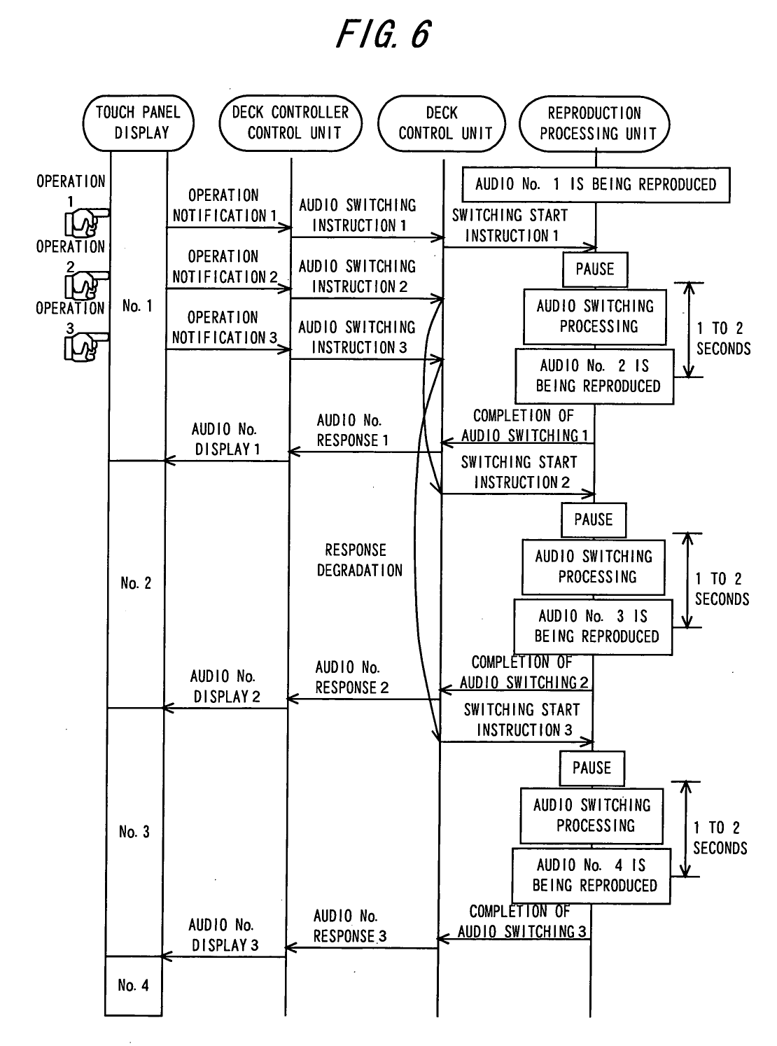

### DESCRIPTION OF EMBODIMENTS

A description is now given of embodiments of a content reproduction system, a reproduction control device, a control method, and a program according to the present invention referring to drawings. The content reproduction system according to the embodiment may be used in various applications such as content reproduction systems installed indoors and outdoors for use as well as vehicle onboard devices and mobile devices.

### First Embodiment

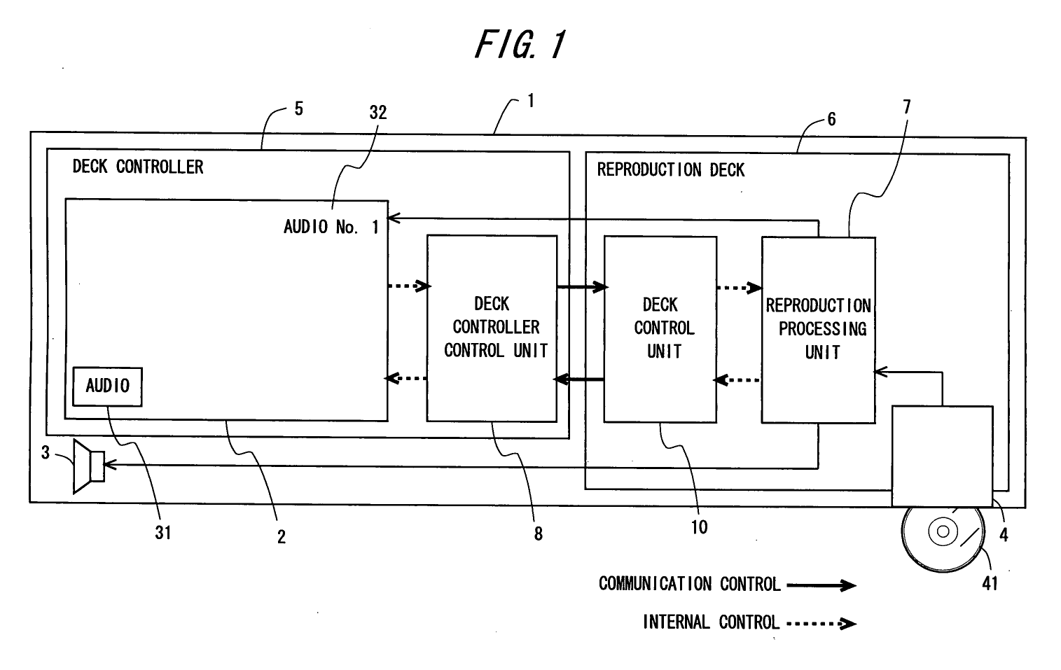

FIG. 1 illustrates a schematic configuration of the content reproduction system according to the embodiment. In the embodiment, a description is given of a content reproduction system 1 that reproduces contents compliant to the DivX standard recorded on a compact disc (CD), a digital versatile disc (DVD), and a Blu-ray disc (BD), as a representative example. Therefore, the content reproduction system 1 illustrated in FIG. 1 includes a multi drive 4 capable of reading discs compliant to a plurality of standards such as CD, DVD, and BD. As the media, other portable recording media may be used, and auxiliary storage systems such as a hard disk drive (HDD) and a flash electrically erasable and programmable read only memory (EEPROM), broadcast waves, and distributions over the Internet may be used.

The DivX standard is a standard enabling selection of an audio to be reproduced in synchronization with a video out of a plurality of audios, and audio data for reproducing those audios is recorded on a medium such as a CD or DVD while the audio data is packaged (as a single file) along with video data of the video reproduced in synchronization therewith. Moreover, according to the DivX standard, after an audio is specified and before the audio is reproduced along with a video, for decoding compressed data, and synchronization with the video, for example, preprocessing is necessary while the video and audio are paused.

Moreover, an audio system according to the embodiment includes, in order to select a desired piece of audio data out of a plurality of pieces of audio data contained in content data compliant with the DivX standard, an interface for selecting audio data, in which an operation of an audio button 31 sequentially switches the listed plurality of pieces of audio data to select the piece of audio data to be reproduced. In the content data, a plurality of pieces of audio data are listed, and, by specifying a number in this list, an audio based on the desired piece of audio data can be reproduced along with a video. When the audio button 31 is operated, audio data listed next to audio data to be reproduced currently is selected, and, when the audio button 31 is operated at the end of the list, audio data at the top of the list is selected as the subject to reproduction. Namely, according to the embodiment, pluralities of pieces of audio data are listed in a loop form.

The content reproduction system 1 according to the embodiment includes a reproduction deck 6 in which data for a content is actually read out, and reproduction processing for the content is carried out, a deck controller 5 that controls the reproduction deck 6, and a speaker 3 that outputs an audio according to an audio signal output from the reproduction deck 6.

The reproduction deck 6 is a device that decodes content data according to an instruction from the deck controller 5, and creates a video signal and an audio signal, and, depending on a medium from which the content data is acquired, is implemented as a reproduction deck 6 of various types. As the medium from which the content data is acquired, there are a portable recording medium such as a CD, a DVD, and a BD, an auxiliary storage system such as an HDD and a flash EEPROM, and a broadcast wave. According to the embodiment, the reproduction deck 6 is a reproduction deck 6 including the multi drive 4, and capable of reading out and reproducing content data recorded on an inserted disc 41 such as the CD or DVD. Moreover, the reproduction deck 6 according to the embodiment includes a reproduction processing unit 7 that actually reads the content data via the multi drive 4, and carries out decoding and signal generation, and a deck control unit 10 that controls the reproduction processing unit 7 by specifying a content to be reproduced by the reproduction processing unit 7. It should be noted that, according to the embodiment, the deck control unit 10 corresponds to the reproduction control device according to the present invention. Moreover, the reproduction deck 6 according to the embodiment is a reproduction deck 6 which supports a codec according to the DivX standard, and can reproduce contents from content data compressed according to the DivX and recorded on a CD or DVD. For this purpose, the reproduction processing unit 7 includes a processor that reproduces content data compliant with the DivX standard.

The deck controller 5 includes a touch panel display 2 that displays a video based on the video signal created by the reproduction deck 6 to reproduce the video, and at the same time, detects a touch on a display by a user and a touched position to receive an input by the user, and a deck controller control unit 8 that controls a reproduced content based on an user operation detected by the touch panel display 2 and buttons provided on a main body and contents of setting. On the touch panel display 2, an audio number display 32 indicating which piece of audio data is being reproduced out of a plurality of pieces of audio data packaged along with video data relating to a video being reproduced, and an audio button 31 for switching audio data being reproduced along with the video are displayed. According to the embodiment, those displays appear when the user depressed a predetermined button, or carries out a predetermined operation via the touch panel display 2 while a video is being reproduced.

The reproduction processing unit 7, the deck control unit 10, the deck controller control unit 8, and the touch panel display 2 constituting the content reproduction system 1 according to the embodiment include at least a general or dedicated processor that controls the respective functional units by processing instructions and data, and include, according to necessity, a random access memory (RAM), a read only memory (ROM), and a hard disk drive (HDD) that stores various data used by the system such as various programs to be loaded on the RAM. Those components including the processor may be provided respectively to the respective functional units, or may be shared by the respective functional units.

The multi drive 4 is an optical disc drive capable of mounting and reading discs (recording media) compliant with a plurality of standards such as a CD, a DVD, and a BD. In the system according to the embodiment, information read from the disc 41 mounted on the multi drive 4 is transmitted to the reproduction processing unit 7. The reproduction processing unit 7 creates a video signal and an audio signal based on the read information. Then, by outputting the video signal and the audio signal created by the reproduction processing unit 7 to the touch panel display 2 and the speaker 3, the content reproduction system 1 reproduces the video and audio.

According to the embodiment, the video signal and the audio signal based on the information read out from the disc 41 are created by the reproduction processing unit 7 including a so-called digital signal processor (DSP) and the like, but the decoding processing may be carried out by a processor that executes a decoding program loaded on the RAM or the like. Moreover, the processing of the video signal and the processing of the audio signal based on the information read out from the disc 41 may be carried out by one processor, but may be carried out respectively by different dedicated processors.

The touch panel display 2 is an input/output device (user interface) for a user in the system, and displays an image notifying the user of certain information and detects a touch operation by the user to a portion of the displayed image to receive a user operation. The content reproduction system 1 receives an operation performed by the user by means of the touch operation to the touch panel display 2 as well as various buttons and the like (not shown) provided on the system 1. Contents input via the touch panel display 2, the buttons, and the like are processed by the reproduction control device. Moreover, a notification to the user made by the system may be output as an audio via the speaker 3.

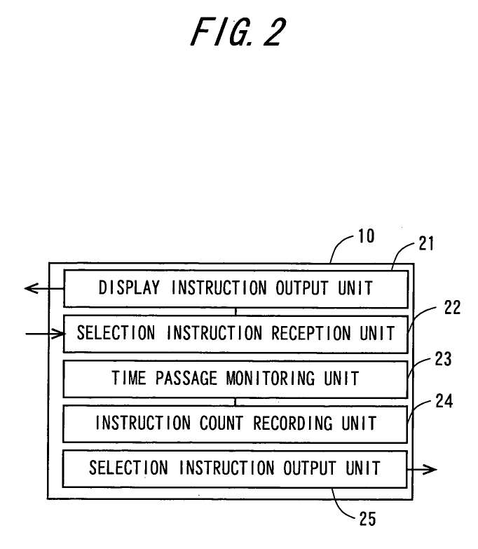

FIG. 2 is a diagram illustrating a functional configuration of the reproduction control device (deck control unit 10) according to the embodiment. The reproduction control device according to the embodiment is a computer including a RAM and a ROM on which programs and the like are loaded, a processor that interprets and executes the program loaded on the RAM or the ROM, and an auxiliary storage system such as an HDD, and, by the processor interpreting and executing the reproduction control program loaded on the RAM or the ROM, functions as the reproduction control device including a selection instruction reception unit 22, a time passage monitoring unit 23, an instruction count recording unit 24, a selection instruction output unit 25, and a display instruction output unit 21.

The selection instruction reception unit 22 receives an audio switching instruction issued as a result of a reception of a user operation detected on the touch panel display 2. The audio switching instruction received on this occasion corresponds to a next-audio-data selection instruction according to the present invention to cause a piece of audio data, which is listed next to the piece of audio data to be reproduced, to be selected as a new piece of audio data to be reproduced out of a plurality of pieces of audio data contained in content data.

The time passage monitoring unit 23 monitors a passage of time until a passage of a predetermined period of time is detected after the audio switching instruction is last received by the selection instruction reception unit 22. According to the embodiment, the predetermined period of time whose passage is monitored is 500 milliseconds (ms). This period of time is a period of time used for regarding successively input audio switching instructions as a group of successive inputs, and it is preferred that an optimal value be appropriately selected and set according to modes of application. In order to enable successive operations by the user, this predetermined period of time needs to be set to a period of time longer than an interval of operations when the user operates the audio button 31 as fast as possible.

The instruction count recording unit 24 updates a target audio number according to the number of the audio switching instructions successively received by the selection instruction reception unit 22 after the selection instruction reception unit 22 receives the audio switching instruction while the time passage monitoring unit 23 has not started the monitoring until the time passage monitoring unit 23 detects the passage of the predetermined period of time. The target audio number is information indicating a switched audio number specified finally by the selection instruction output unit 25 according to the embodiment.

The selection instruction output unit 25 outputs a specified-audio-data selection instruction to the content reproduction system 1 when the time passage monitoring unit 23 detects the passage of the predetermined period of time. The specified-audio-data selection instruction output on this occasion is an instruction to cause a piece of audio data, which relates to the target audio number updated by the instruction count recording unit 24, to be selected as a new piece of audio data to be reproduced out of the plurality of pieces of audio data contained in the content data.

When the selection instruction reception unit 22 receives the audio switching instruction, regardless of whether or not the instruction output unit has output an instruction to the content reproduction system 1, the display instruction output unit 21 outputs a response notification of the audio number to the touch panel display 2 provided to the content reproduction system 1.

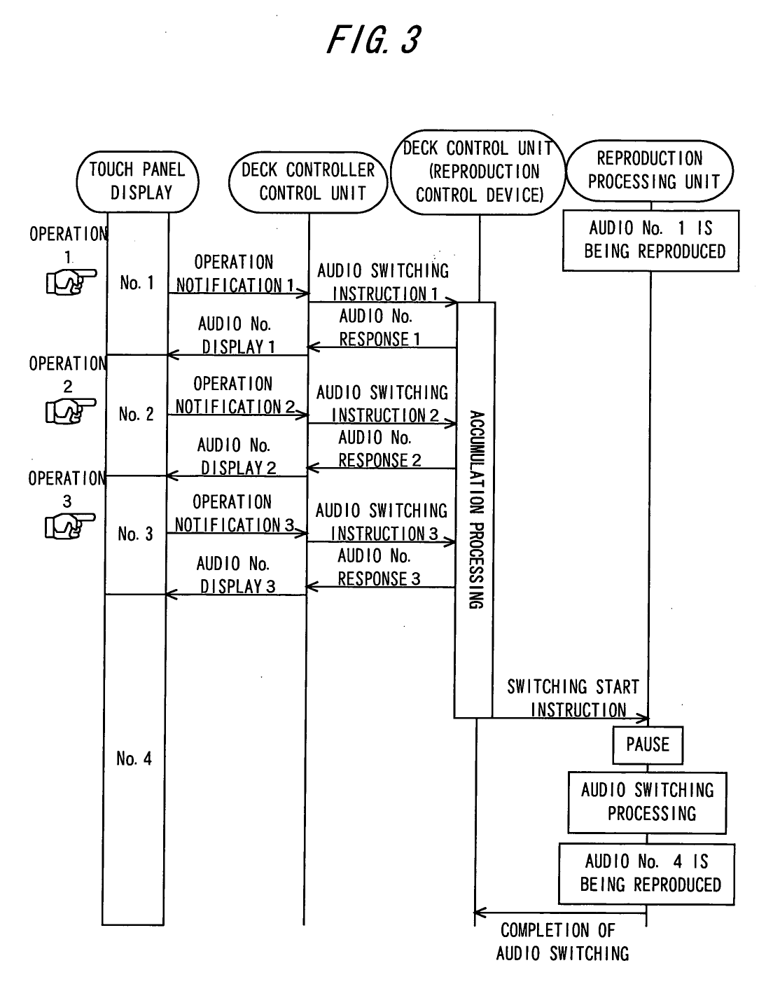

A more detailed description is now given of contents of reproduction control processing according to the embodiment referring to sequence diagrams and a flowchart illustrated in FIG. 3 to FIG. 5. FIG. 3 is a sequence diagram illustrating a flow of the reproduction control processing according to the embodiment. In the sequence diagram, it is assumed that, first, an audio of audio number 1 is being reproduced along with a video, and, on the touch panel display 2, the fact that the audio number of the audio currently being reproduced is 1, and the audio button 31 are being displayed along with the reproduced video (refer to an illustration of the display on the touch panel display 2 illustrated in FIG. 1). It should be noted that the audio number display 32 and the audio button 31 may be hidden by setting in the content reproduction system 1 or an operation. When the audio number display 32 and the audio button 31 are hidden, the user causes the audio number display 32 and the audio button 31 to be displayed on the touch panel display 2 by an operation such as touching the touch panel display 2 or depressing a display button provided on the deck controller 5.

When the user touches a display portion of the audio button 31 on the touch panel display 2, the touch panel display 2 detects that the user touches the display portion of the audio button 31, and transmits an audio button operation notification based on this user operation to the deck controller control unit 8. Upon receiving the audio button operation notification, the deck controller control unit 8 transmits an audio switching instruction to switch the audio data to be reproduced to audio data listed next to the audio data to be currently reproduced, to the deck control unit 10 (reproduction control device).

On this occasion, according to a conventional configuration, upon receiving the audio switching instruction, the deck control unit 10 transmits an audio switching start instruction to switch the audio data to be reproduced to the next audio data, and reproduce the next audio data, to the reproduction processing unit 7, but the deck control unit 10 according to the embodiment starts the monitoring of a passage of time after the audio switching instruction is first received, and accumulates the audio switching instructions. On this occasion, processing involving the start of the accumulation of the audio switching instructions, the end of the accumulation, and the outputting of the audio switching start instruction to the reproduction processing unit 7 is referred to as accumulation processing.

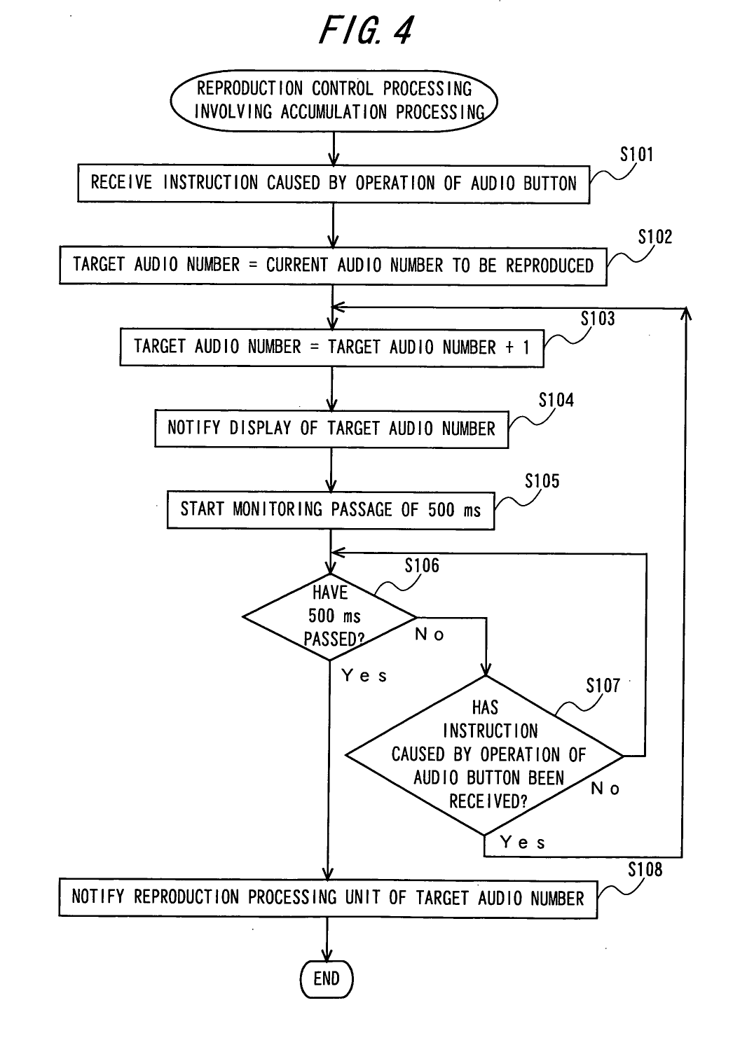

FIG. 4 is a flowchart illustrating a flow of the reproduction control processing involving the accumulation processing according to the embodiment. The processing illustrated in the flowchart is started when the deck control unit 10 receives the audio switching instruction while the accumulation processing is not carried out, and is carried out by the deck control unit 10.

In Step S101 and Step S102, an instruction caused by the operation of the audio button 31 is received, and data necessary for the accumulation processing is initialized. The selection instruction reception unit 22 receives the audio switching instruction issued by the deck controller control unit 8 resulting from the operation of the audio button 31 displayed in the touch panel display 2 by the user (Step S101). Then, the instruction count recording unit 24 initializes the target audio number to be finally instructed to the reproduction processing unit 7 to the audio number to be reproduced of an audio which is currently being reproduced. For example, when the audio number of the audio being reproduced along with a video is 1, the target audio number is set to 1. Then, the processing proceeds to Step S103.

In Step S103 and Step S104, the target audio number is updated and displayed. As a result of the operation of the audio button 31 being notified, the instruction count recording unit 24 adds 1 to the target audio number to update audio data indicated by the target audio number to audio data listed next to the audio data indicated by the target audio number before the update (Step S103). Then, the display instruction output unit 21 outputs to the touch panel display 2 an instruction to update the display of the audio number by indicating the updated target audio number (Step S104). As a result, the audio number displayed on the touch panel display 2 is updated immediately according to the operation by the user, and the user can recognize that the own operation has been normally received. It should be noted that, in the processing of updating the target audio number in Step S103, the target audio number does not exceed the total number of pieces of audio data contained in the content data. In other words, when the number of pieces of audio data being reproduced and contained in the content data is 8, namely, when selectable audio numbers are 1 to 8, and when the target audio number is updated while the target audio number is 8, the target audio number is set to 1. Then, the processing proceeds to Step S105.

In Step S105, the monitoring of time passage is started. As a result of the reception of the instruction caused by the operation of the audio button 31 in Step S101, the time passage monitoring unit 23 starts monitoring the passage of the predetermined period of time (500 ms according to the embodiment). When the time passage has already been monitored, the monitored passage is reset, and the monitoring of the time passage starts again from the beginning (0 ms). Moreover, in the flowchart illustrated in FIG. 4, the timing at which the monitoring of the time passage starts is described as a time after the processing in Step S104 of notifying the touch panel display 2 of the target audio number, but the monitoring of the time passage is intended to monitoring of the time passage for measuring the operation interval of the audio button 31, and the timing of the start may be any time as long as the timing is the time after the operation of the audio button 31 is detected. In order to accumulate the audio switching instructions based on a precise operation interval, the monitoring of the time passage is preferably started as early as possible after the operation of the audio button 31 is detected.

In Step S106 and Step S107, an instruction caused by the operation of the audio button 31 (audio switching instruction) performed within 500 ms after the monitoring of the time passage has started is received. The time passage monitoring unit 23 monitors a passed time after the monitoring of the time passage has started, and determines periodically whether or not 500 ms have passed by using a method of periodically acquiring a current time from a system clock. As a specific method used for monitoring the time passage, another method may be employed. When it is determined that 500 ms have passed, the processing proceeds to Step S108. When it is determined that 500 ms have not passed, the processing proceeds to Step S107, and the selection instruction reception unit 22 determines whether or not the audio switching instruction has been received. In other words, in Step S107, it is determined whether or not the audio switching instruction has been received within 500 ms after the monitoring of the time passage has started. When the audio switching instruction has been received, the processing proceeds to Step S103, and when the audio switching instruction has not been received, the processing proceeds to Step S106. Therefore, the processings described in Step S106 and Step S107 are repeated until 500 ms have passed, or until the audio switching instruction is received.

When the audio switching instruction is received before 500 ms have passed after the last audio switching instruction, the processing proceeds to Step S103, the update of the target audio number (Step S103) and the notification to the touch panel display 2 (Step S104) are carried out, and the monitoring of the passage of 500 ms starts again (Step S105). In other words, according to the flowchart, as long as the new audio switching instruction is received within 500 ms after the last audio switching instruction, the target audio number is updated by the number of the received audio switching instructions (number of operations of the audio button 31). In this period of time, to the reproduction processing unit 7 actually carrying out the reproduction processing of the content, the audio switching start instruction to switch the audio data to be reproduced is not issued.

When 500 ms have passed after the last audio switching instruction, the processing proceeds to Step S108. In Step S108, the audio switching start instruction is notified to the reproduction processing unit 7. The selection instruction output unit 25 outputs the audio switching start instruction to switch the audio data to be actually reproduced to the reproduction processing unit 7 by specifying the target audio number updated according to the number of the received audio switching instructions (refer to Steps S102 and S103) as the current audio number to be reproduced. Then, the flowchart ends.

Upon receiving the audio switching start instruction, the reproduction processing unit 7 pauses the reproduction of the video and audio, and carries out the audio switching processing (refer to FIG. 3). On this occasion, audio data relating to the target audio number contained in the audio switching start instruction is read out, the preprocessing for reproduction such as start of the decoding, and the synchronization with the video is carried out, and the reproduction of the video and audio starts simultaneously. On this occasion, the reproduction of the video and audio starts from a neighborhood of a position of the pause, but for the audio, reproduction of the audio based on audio data different from audio data before the pause starts. In the example illustrated in FIG. 3, the audio button 31 has been operated three times, and hence, when the audio number of the audio having been reproduced before the operation is 1, the target audio number is 4. When the audio data to be reproduced has been switched, and the reproduction of the video and the audio relating to the audio number 4 starts, the reproduction processing unit 7 transmits an audio switching completion notification to the deck control unit 10. It should be noted that, when the audio switching instruction is received when 500 ms have passed after the last audio switching instruction has been received, the processing starting from Step S101 starts again.

According to the embodiment, even when the user successively carries out the operations of switching an audio, the instructions based on the operations are once accumulated, and, when it is determined that the successive operations have been finished, an instruction of a final audio switching based on the successive operations is output. As a result, even when the reproduction of video and audio needs to be paused for the preprocessing performed for switching the audio, execution of the unnecessary audio switching processing is eliminated. Further, the switching is completed by the switching processing performed only once, and hence a waiting time of the user after the user carries out the operation until the switching to an audio desired by the user is finally finished can be reduced. Moreover, even after the accumulation processing starts, the reproduction of the video and audio continues until the audio switching start instruction is issued when the accumulation processing is finished, and hence a period of time of video pause/silence can be reduced. Further, instructions based on operations are accumulated, but the audio number display 32 displayed on the touch panel display 2 is updated following the user operation. Hence, the user can recognize that the operations are correctly input.

It should be noted that, as the audio number display 32, in place of the numerical display described in the embodiment, there may be employed a display using “Japanese” or “English” by which the user can recognize a description of the selected audio. This display can be realized by reading, from the content data, the description of the audio data contained in the content data, and displaying the read information. For example, according to the DivX Ultra standard, information representing a description of an audio is contained in content data, and thus, the information can be read out from the content data, and the description of the audio being reproduced can be displayed.

### Second Embodiment

The reproduction control processing described in the first embodiment may be carried out by the deck controller 5 in the configuration of the content reproduction system 1 illustrated in FIG. 1. In other words, in this case, the deck controller control unit 8 corresponds to the reproduction control device according to the present invention. In other words, in the embodiment, as a result of the processor interpreting and executing a reproduction control program loaded on the RAM or ROM, the deck controller control unit 8 functions as the reproduction control device including the selection instruction reception unit 22, the time passage monitoring unit 23, the instruction count recording unit 24, the selection instruction output unit 25, and the display instruction output unit 21 illustrated in FIG. 2.

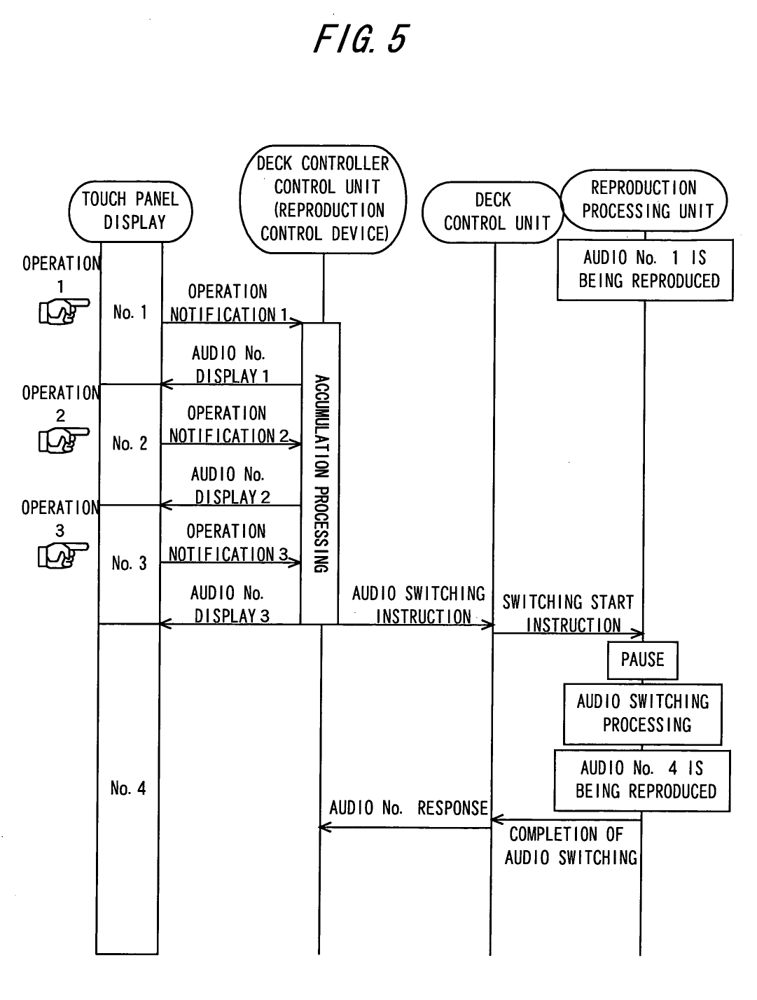

FIG. 5 is a sequence diagram illustrating a flow of the reproduction control processing according to the embodiment. As in the first embodiment, in the sequence diagram, it is assumed that, first, an audio of audio number 1 is being reproduced along with a video, and, on the touch panel display 2, the fact that the audio number of the audio currently being reproduced is 1, and the audio button 31 are being displayed along with the reproduced video. According to the embodiment, the audio button operation notification notified by the touch panel display 2, which has detected an operation of the audio button 31 by a user, to the deck controller control unit 8 corresponds to the next-audio-data selection instruction according to the present invention. In other words, based on the audio button operation notifications successively input at intervals each equal to or less than 500 ms, the deck controller control unit 8 updates the target audio number, and issues the audio switching instruction to the reproduction deck 6 according to the final number of the operations represented by the audio button operation notifications. This audio switching instruction is an audio switching instruction containing a target audio number. The reproduction control processing involving the accumulation processing carried out by the deck controller control unit 8 is substantially the same as the contents of the processing described referring to FIG. 4, and a description thereof is therefore omitted. According to the embodiment, as in the first embodiment, it is possible to reduce the waiting time of the user upon the audio switching, reduce the period of time of video pause/silence caused by the switching, and update the audio number display following the user operation.

What is claimed is:

1. A reproduction control device connected to a content reproduction system that reproduces, along with a video based on video data, an audio based on a piece of audio data to be reproduced, which is selected out of a plurality of pieces of audio data that require preprocessing to be carried out before start of reproduction, and constitute a content along with the video data, the reproduction control device comprising:
selection instruction reception means for receiving a next-audio-data selection instruction to cause a piece of audio data, which is listed next to the piece of audio data to be reproduced, to be selected as a new piece of audio data to be reproduced out of the plurality of pieces of audio data;
instruction count recording means for recording a number of the next-audio-data selection instructions successively received by the selection instruction reception means; and
selection instruction output means for outputting, to the content reproduction system, a specified-audio-data selection instruction to cause a piece of audio data, which is listed after the piece of audio data to be reproduced with an interval corresponding to the number of the next-audio-data selection instructions recorded by the instruction count recording means, to be selected as the new piece of audio data to be reproduced out of the plurality of pieces of audio data.

2. A reproduction control device according to claim 1, further comprising time passage monitoring means for monitoring a passage of a period of time until a passage of a predetermined period of time is detected after the next-audio-data selection instruction is last received by the selection instruction reception means, wherein:
the instruction count recording means records the number of the next-audio-data selection instructions received by the selection instruction reception means after the selection instruction reception means receives the next-audio-data selection instruction while the time passage monitoring means has not started the monitoring until the time passage monitoring means detects the passage of the predetermined period of time; and
the selection instruction output means outputs, when the time passage monitoring means detects the passage of the predetermined period of time, the specified-audio-data selection instruction to the content reproduction system.

3. A reproduction control device according to claim 1, further comprising display instruction output means for outputting, when the selection instruction reception means receives the next-audio-data selection instruction, regardless of whether or not the selection instruction output means outputs the selection instruction to the content reproduction system, an instruction to display, on a display unit provided on the content reproduction system, a notification that the piece of audio data, which is listed next to the piece of audio data to be reproduced, out of the plurality of pieces of audio data, has become the new piece of audio data to be reproduced.

4. A reproduction control device according to any one of claim 1, wherein the plurality of pieces of audio data are listed in a form of loop.

5. A reproduction control device according to any one of claim 1, wherein the preprocessing comprises at least one of processing of reading out data necessary for the reproduction from a recording medium, processing of loading the data on a storage system, processing of decoding compressed data, and processing of synchronizing the reproduced audio with the video.

6. A reproduction control method carried out by a reproduction control device connected to a content reproduction system that reproduces, along with a video based on video data, an audio based on a piece of audio data to be reproduced, which is selected out of a plurality of pieces of audio data that require preprocessing to be carried out before start of reproduction, and constitute a content along with the video data, the reproduction control method comprising:
a selection instruction reception step of receiving a next-audio-data selection instruction to cause a piece of audio data, which is listed next to the piece of audio data to be reproduced, to be selected as a new piece of audio data to be reproduced out of the plurality of pieces of audio data;
an instruction count recording step of recording a number of the next-audio-data selection instructions successively received in the selection instruction reception step; and
a selection instruction output step of outputting, to the content reproduction system, a specified-audio-data selection instruction to cause a piece of audio data, which is listed after the piece of audio data to be reproduced with an interval corresponding to the number of the next-audio-data selection instructions recorded in the instruction count recording step, to be selected as the new piece of audio data to be reproduced out of the plurality of pieces of audio data.

7. A reproduction control method according to claim 6, wherein the preprocessing comprises at least one of processing of reading out data necessary for the reproduction from a recording medium, processing of loading the data on a storage system, processing of decoding compressed data, and processing of synchronizing the reproduced audio with the video.

8. A readable-by-computer recording medium recorded with a reproduction control program causing a computer connected to a content reproduction system that reproduces, along with a video based on video data, an audio based on a piece of audio data to be reproduced, which is selected out of a plurality of pieces of audio data that require preprocessing to be carried out before start of reproduction, and constitute a content along with the video data, to function as:
selection instruction reception means for receiving a next-audio-data selection instruction to cause a piece of audio data, which is listed next to the piece of audio data to be reproduced, to be selected as a new piece of audio data to be reproduced out of the plurality of pieces of audio data;
instruction count recording means for recording a number of the next-audio-data selection instructions successively received by the selection instruction reception means; and
selection instruction output means for outputting, to the content reproduction system, a specified-audio-data selection instruction to cause a piece of audio data, which is listed after the piece of audio data to be reproduced with an interval corresponding to the number of the next-audio-data selection instructions recorded by the instruction count recording means, to be selected as the new piece of audio data to be reproduced out of the plurality of pieces of audio data.

9. A readable-by-computer recording medium recorded with a reproduction control program according to claim 8, wherein the preprocessing comprises at least one of processing of reading out data necessary for the reproduction from a recording medium, processing of loading the data on a storage system, processing of decoding compressed data, and processing of synchronizing the reproduced audio with the video.
